(19) United States
(12) Patent Application Publication
(10) Pub. No.: US 2012/0293109 A1
(43) Pub. Date: Nov. 22, 2012

(54) Method and System for Efficiently Exploiting Renewable Electrical Energy Sources

(76) Inventor: Yariv Glazer, Ann Arbor, MI (US)

(21) Appl. No.: 13/468,182

(22) Filed: May 10, 2012

Related U.S. Application Data
(60) Provisional application No. 61/487,734, filed on May 19, 2011.

(51) Int. Cl. H02J 7/00; F03D 9/00; H01R 43/00; H02J 17/00

(52) U.S. Cl. 320/101; 290/1 R; 290/55; 29/825

(57) ABSTRACT

A method and system for efficiently exploiting renewable electrical energy sources by: constructing an electrical distribution network along and proximal to a roadway network traveled by electrical vehicles; introducing a plurality of removable electrical energy sources into the electrical distribution network at a plurality of spaced locations therein; and utilizing the plurality of renewable electrical energy sources in the electrical distribution network for powering fixed electrical facilities located along and proximal to the roadway network and also electrical vehicles traveling on the roadway network.

### RELATED APPLICATION

The present application is a continuation-in-part application of Provisional Application 61/487,734, filed May 19, 2011, hereby incorporates by reference, and claims the priority date of that application.

### FIELD AND BACKGROUND OF THE INVENTION

The present application relates to a method and system for efficiently exploiting renewable electrical energy sources.

The term “renewable electrical energy sources”, as used herein, refers to electrical energy sources that are constantly and substantially replenished, as distinguished from non-renewable sources, such as oil, combustible gases, coal, and shale fossil fuels which have accumulated over many centuries of time. Preferred examples of renewable electrical energy sources include not only wind energy and solar energy, but also bio-mass energy, ethanol, bio-gas and geothermal energy.

The invention particularly relates to a method and system for achieving a sustainable, integrated, electrical refueling system by positioning renewable energy harvesting units in such manner not only to provide electricity to plants, businesses and communities located along a roadway network, but also to refuel electrical vehicles.

Various methods and systems have been used for designing renewable electrical energy plants, for example, wind farms, solar farms, and manure digesters, to produce power to homes, plants, or other electrical consumption facilities at fixed locations, and also to provide power to mobile electrical vehicles.

The known systems, however, have usually required the allocation of substantial land areas for installing the renewable electrical energy source, (e.g., wind-turbines and/or solar panel), and also the electrical distribution networks or grids for conveying the so-generated electrical energy to the electrical facilities or electrical vehicles to be powered. As a result, the costs for using such renewable electrical energy sources are extremely high, making them commercially non-feasible except for relatively few applications. Supplying electrical energy from such sources to electrical vehicles is even more problematical because of the distances involved in conveying the electrical energy from such remotely-located sources to the electrical vehicle.

It is also known to provide data communication network to permit data communication from one area to another, or within a particular area. Such networks also involve large installation costs and the allocation of large land areas.

### OBJECTS AND BRIEF SUMMARY OF THE PRESENT INVENTION

An object of the present invention is to provide a method and system for exploiting renewable energy sources having advantages in the above respects.

A more particular object of the present invention is to provide a multi-functional, distributed, integrated method and system for generating renewable electrical energy, and for transporting such energy to the point of consumption, while at the same time providing data communication network for conveying data from area to area, or within a given area.

According to a broad aspect of the present invention, there is provided a method of efficiently exploiting renewable electrical energy sources, comprising: constructing an electrical distribution network along and proximal to a roadway network traveled by electrical vehicles; introducing a plurality of renewable electrical energy sources into the electrical distribution network at a plurality of spaced locations in the electrical distribution network; utilizing the plurality of renewable electrical energy sources in the electrical distribution network for powering fixed electrical facilities located along and proximal to the roadway network; and utilizing the plurality of renewable electrical energy sources in the electrical distribution network also for powering mobile electrical vehicles traveling on the roadway network via electrical energy transfer devices in the electrical distribution network and on the electrical vehicles.

According to further features in the preferred embodiments of the invention described below, the method may further comprise constructing a data communication network along and proximal to the roadway network; and providing the electrical distribution network with access points for enabling wireless access to the data communication network by travelers along the roadway network.

According to still further features in the described preferred embodiments, the method may further comprise providing an energy storage system for temporarily storing energy outputted by the renewable electrical energy sources until utilized for powering the fixed energy facilities and the electrical vehicles.

Embodiments of the invention are described below wherein the renewable electrical energy sources include wind-turbines each driving an electrical generator for generating electrical energy from the wind, and also solar panels for generating electrical energy from the sun.

In one described embodiment, the electrical energy transfer devices in the electrical distribution network include electrical sockets at fixed locations of the electrical distribution network, and electrical plugs carried by the electrical vehicle for charging batteries carried by the electrical vehicle. However, other types of such electrical energy transfer devices could be used.

Thus, in a second described preferred embodiment, the electrical energy transfer devices in the electrical distribution network include coils embedded in the roadway network, each conducting electrical energy outputted from the renewable electrical energy sources in the form of alternating current; and the electrical energy transfer devices of the electrical vehicles include a coil carried by each electrical vehicle and inductively coupled to the embedded coils when the electrical vehicle is located thereover on the roadway network.

In a third described preferred embodiment, the electrical energy transfer devices of the electrical distribution network include a linear array of coils embedded in the roadway network, each conducting electrical energy outputted from the renewable electrical energy sources in the form of current alternating in direction in adjacent coils; and the electrical energy transfer devices of the electrical vehicles include a coil carried by each electrical vehicle and inductively coupled to the embedded coils as the electrical vehicle moves over the roadway network.

In a fourth described preferred embodiment the electrical energy transfer devices of the electrical distribution network include electrically-conductive strips embedded in the roadway network; and the electrical energy transfer devices of the electrical vehicles include electrical contactors carried by each of the electrical vehicles and movable in electrical contact with the electrically-conductive strip embedded in the roadway network as the electrical vehicle moves over the roadway network.

According to another aspect of the present invention, there is provided a system for efficiently exploiting renewable electrical energy sources according to the method briefly set-forth above.

As will be described more particularly below, such a method and system minimize the land areas required to be allocated for installing the renewable electrical energy sources and for conveying the generated energy to the points of consumption, as compared to the existing methods and systems. In addition, the novel method and system better accommodate the fluctuations in the energy consumption at any particular location thereby providing more efficient generation and distribution of such electrical energy to all points of consumption.

The invention may also be implemented to provide an electrical vehicle refueling system, comprising: renewable energy generators distributed along the road; a grid or electrical distribution network collecting the electricity from the generators and distributing it to refueling stations and businesses along the road; refueling stations positioned at exits from the road; electromagnetic refueling systems embedded within the road for moving vehicles; and a data communication network serving as a data backbone for controlling and monitoring the system and for providing a wireless data blanket over the road for providing data communication for road travelers and for monitoring the health of the system.

In the described preferred embodiments, the electrical renewable energy generators for refueling the electrical vehicles are thus distributed along the road, thereby utilizing the land resources of the road to harvest the energy (wind, solar, etc.). The positioning of many windmills along a west-east road captures the wind waves from start to finish of the wave-movement path. The system thus creates a continuous generation capability, with several windmills positioned in the peak wind speed areas, providing energy to the rest of the system. When using solar panels or solar towers, the spread of the generators from east to west extends the exposure time of the system to the sun.

Also, the energy distribution grid collects the energy from the generators to be distributed to the refueling stations and businesses along the road. The refueling stations are positioned by the generators and receive the energy from the grid. Since the distribution of the refueling stations is in accordance with the location of the generators, this reduces the energy transport needs and increases the energy availability and sustainability of the system.

Still further, the data backbone communication network, which connects the components of the system, is powered by the grid, and carries high capacity data at high speed to consumers along the road. Wireless data access points distributed on the electrical distribution network, create a wireless coverage blanket of high speed and high capacity for travelers and businesses within the road reach.

### BRIEF DESCRIPTION OF THE DRAWINGS

The invention is herein described, by way of example only, with reference to the accompanying drawings, wherein:

FIG. 1 is a schematic diagram illustrating a system constructed according to the present invention;

FIG. 2 is a flow chart illustrating the overall operation of the system of FIG. 1;

FIG. 3 is a schematic diagram illustrating a preferred embodiment of the invention;

FIG. 4 is a schematic diagram illustrating another preferred embodiment of the invention;

and FIGS. 5, 6 and 7 are schematic diagrams illustrating further embodiments of the invention particularly with respect to the electrical energy transfer devices that could be used for transferring the energy from the electrical distribution network to the electrical vehicles.

It is to be understood that the forgoing drawings, and the description below, are provided primarily for purpose of facilitating understanding the conceptual aspects of the invention and possible embodiments thereof, including what is considered to be preferred embodiments. In the interest of clarity and brevity, no attempt has been made to provide more details then necessary to enable one skilled in the art, using routing skill and design, to understand and practice the described invention. It is to be further understood that the embodiments described are for purpose of example only, and that the invention is capable of been embodied in other forms and applications than described herein.

### DETAILED DESCRIPTION OF THE INVENTION

Some Background Considerations

Weather fronts move from west to east. Generally, the front carries two peaks of wind speed, and continues to move in a sweeping like movement over the land. A spread of wind-turbines along the front path will ensure capturing these peaks in wind energy into the system, creating a continuous power supply to the refueling system customers.

Creating a wide-spread, self-sustaining, refueling system is economically advantageous. Without the self-generation of electricity, many countries do not have sufficient generation capacity to power a meaningful electric vehicle fleet. This is because the refueling infrastructure does not exist, and the grid or electrical distribution network to supply energy to the refueling stations is limited.

Another key road block for implementing a large electric vehicle fleet is the financing of the road. Today, the roads are paid for in part by taxes on fuel, but with the move to electricity, this revenue source will dry up. A system with wide-spread generation capabilities in accordance with the present invention can pay for the road by selling excess energy, data access, and energy buffering service to communities and businesses along the road.

Sunny areas can be used to boost the power needs of the refueling system. Although solar energy production is limited to the day time, distributing the solar panels from east to west can extend the production window of the system.

The most common energy storage system is by pumping water to an upper level during low consumption times, and using the water to power hydro-electric turbines during peak times. Pressuring a gas (e.g., methane, air), and using the potential energy of the pressured gas at a later time, can produce an energy reservoir where the energy storage is partly or completely in the pipes. Using pipes as a gas storage system thus eliminates the need to create a large water reservoir storage facility, since the pipes can act as the storage reservoir to buffer production fluctuations.

A wireless refueling system may be in the form of an electromagnetic field under the road, with sensors to locate the moving vehicles. The sensors activate electromagnet coils with alternating current for the period of time that the vehicles is above the coil, creating a magnetic field in a vehicle coil that converts to electricity and charges a battery carried by the vehicle.

### DESCRIPTION OF PREFERRED EMBODIMENTS

FIG. 1 schematically illustrates one system constructed according to the present invention for efficiently exploiting renewable electrical energy sources powering electrical vehicles traveling along a highway or roadway network, generally designated 10, and also for powering fixed electrical facilities, generally designated 40, located along and proximal to the roadway network.

As shown in FIG. 1, an electrical distribution network 20, schematically indicated by towers, is constructed along and proximal to the roadway network 10 traveled by electrical vehicles. Network 20 includes a plurality of renewable electrical energy sources, schematically indicated as 30, each including a wind-turbine 31 driving a generator 32, for introducing electrical energy into the electrical distribution network at a plurality of spaced locations along the electrical distribution network. For example, a wind-turbine 31 and a generator 32 may be installed every mile so as to create a continuous generation grid in the electrical distribution network substantially immune from local wind fluctuations.

In FIG. 1, the fixed electrical facilities served by renewable electrical energy sources 30, and schematically indicated at 40, may include restaurants, homes, plants and other businesses located along the roadway network 10. The electrical vehicles powered by the so-generated electrical energy from the electrical distribution network 20 are schematically indicated as 50.

Each refueling station utilizing the so-generated energy for powering electrical vehicles is schematically indicated as 60. Each includes an electrical energy transfer device in the form of an outlet socket 61 at the respective location of the electrical distribution network, and another electrical energy transfer device in the form of an inlet plug 62 carried by the vehicle for charging a rechargeable battery 51 on each vehicle 50.

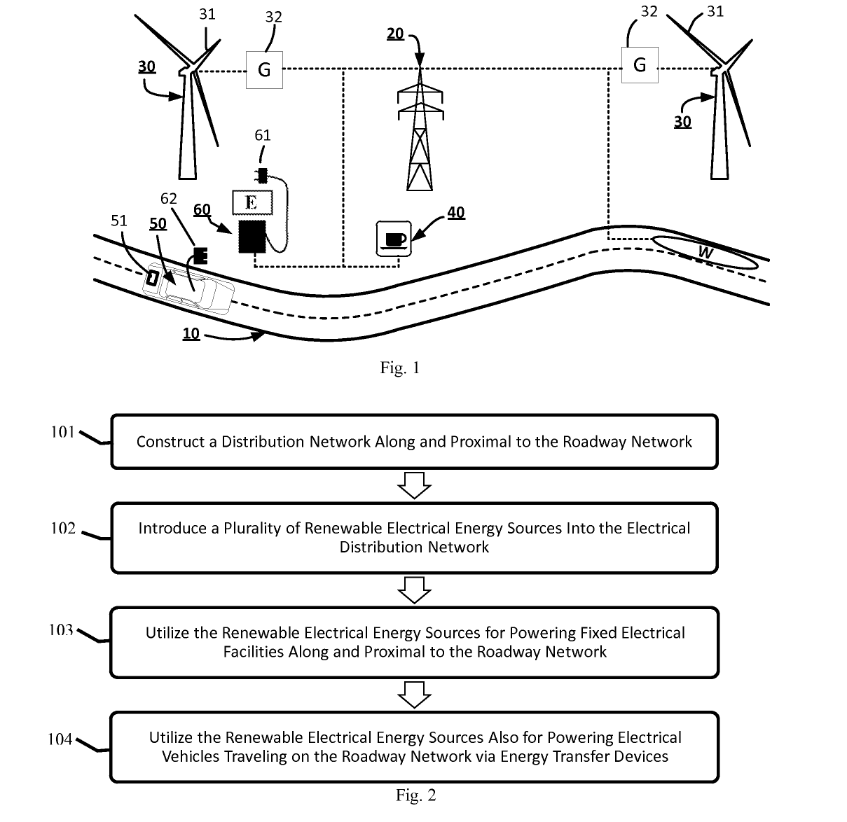

The system of FIG. 1 is implemented, as shown in the flow diagram of FIG. 2, as follows: first, construct the electrical distribution network 20 along and proximal to the roadway network 10 (operation 101); introduce a plurality of renewable electrical energy sources 30 into the electrical distribution network 20 (operation 102); utilize the renewable electrical energy sources 30 for powering the fixed electrical facilities 40 along and proximal to the roadway network (operation 103); and utilize the renewable electrical energy sources 30 also for powering electrical vehicles 50 traveling on the roadway network 10 via the energy transfer devices at the respective refueling station 60.

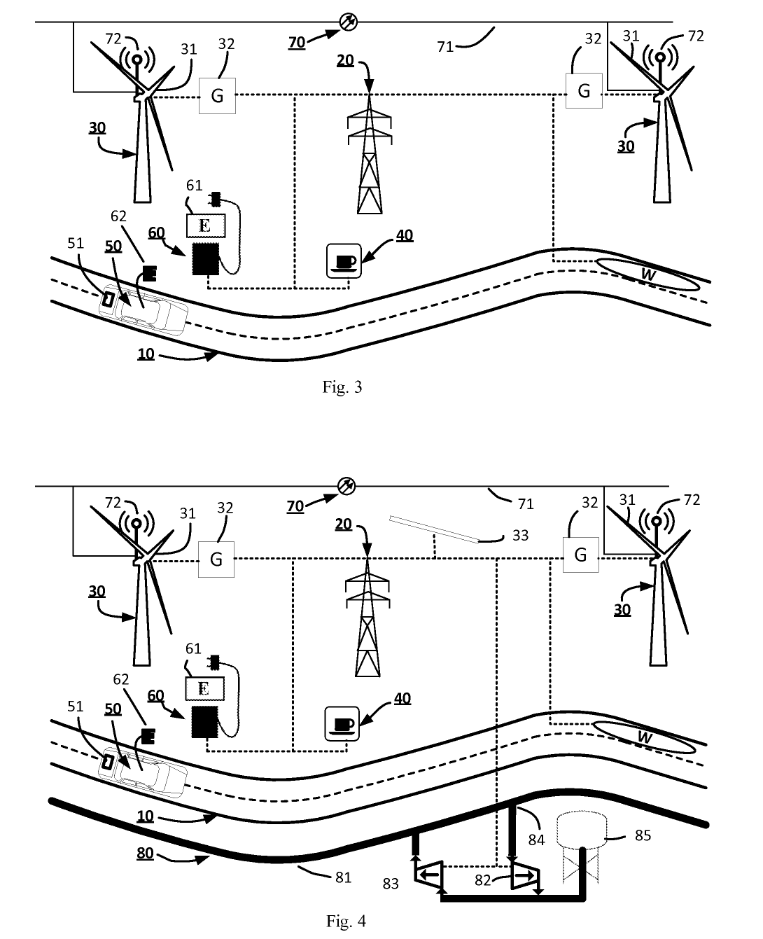

FIG. 3 schematically illustrates a similar system wherein a data communication network generally designated 70, has been added. Network 70 is schematically illustrated as including an optical fiber grid 71 for controlling and monitoring the system components, and also for providing wireless communication, e.g., for travelers along the roadway network 10. The access points for the data communication network 70 are schematically indicated at 72 and may be antenna mounted on the towers of the electrical distribution network 20.

The remainder of the system illustrated in FIG. 3 is the same as described above with respect to FIG. 1, and therefore the same reference numerals have been used for identifying its various elements.

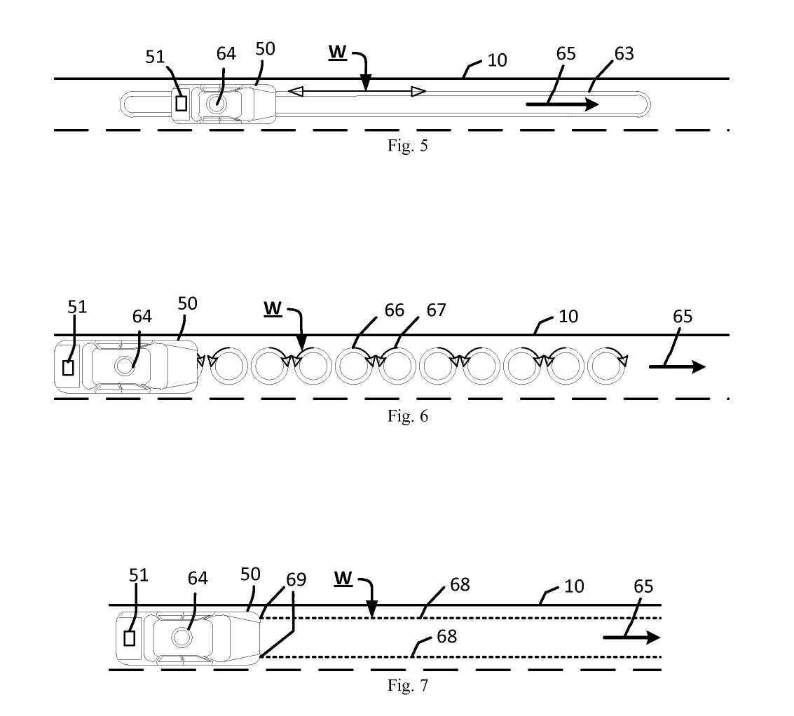

FIG. 4 schematically illustrates another system constructed in accordance with the present invention, which is similar to that of FIG. 3, but adds an energy storage system, generally designated 80, for temporarily storing energy outputted by the renewable electrical energy sources 30 until utilized for powering the fixed electrical facilities 40, and the electrical vehicles 50. Energy storage system 80, as schematically shown FIG. 4, includes a water-piping grid or pipeline 81 through which water is pumped by a pump 82 energized by the electrical distribution network 20 for pumping the water from pipeline 81 via an inlet/outlet port 84 to a water reservoir 85. It further includes a hydro-generator 83 for converting the potential energy of the water while flowing back from the water reservoir 85, to electricity and returning it to the electrical distribution network 30.

Reservoir 85 may be a closed reservoir containing a chamber of a compressible gas (e.g., methane, air) for storing the energy generated by the renewable electrical energy sources 30 until needed for powering the fixed electrical facilities 40, the electrical vehicles 50, and the data communication network 70. Alternatively, it could be an open reservoir which stores this energy in the form of an increase in the elevation of the water pumped from the pipeline 81.

In FIGS. 1, 2 and 4, the renewable electrical energy sources 30 are schematically shown as being in the form of wind-turbines 31 for driving generators 32. As noted above, other renewable electrical energy sources could use, for example, solar cells. One such solar cell is schematically illustrated in FIG. 4 at 33. It will be appreciated that the system could include the combination of a plurality of wind-turbines and solar cells, and that the solar cell could also include tracking devices for tracking the movement of the sun in order to maximize the solar radiation received from the sun.

The system illustrated in FIG. 4 is otherwise the same as described above with respect to FIG. 3, and therefore includes the same reference numerals for identifying its respective elements.

In all of the above described systems, the electrical energy transfer devices at each refueling station, schematically designated 60, are utilized for powering the electrical vehicles traveling on the roadway network 10. In FIGS. 1, 2 and 4, the electrical energy transfer devices in the electrical distribution network 20 are locations “W” and are schematically indicated by electric outlet sockets 61; and the electrical energy transfer devices on the electrical vehicles are schematically indicated by electric plugs 62 carried by the electrical vehicles.

FIGS. 5-7 illustrates further options that may be used for such electrical energy transfer devices, either together with the devices illustrated in FIGS. 1, 2 and 4, or in lieu of such devices.

Thus, FIG. 5 illustrates the option wherein the electrical energy transfer devices located at fixed locations of the electrical distribution network include embedded coils 63 at each location W (FIGS. 1, 3 and 4) in the roadway network 10, each conducting electrical energy outputted from the respective renewable electrical energy source in the form of alternating current; and the electrical energy transfer devices of the electrical vehicles 50 are schematically indicated as including a coil 64 carried by each electrical vehicle 50 and inductively coupled to the embedded coils 63 when the electrical vehicle is located thereover at location W on the roadway network. Thus, as the electrical vehicle travels in the direction indicated by arrow 65 in FIG. 5, the position of the vehicle coil 64 over the embedded coil 63 generates a voltage which is used to charge a rechargeable battery, schematically indicated 51 and carried by the vehicle, for powering the vehicle.

It will be appreciated that in the system schematically illustrated in FIG. 5, since an alternating current is passed through the coils 63 embedded in the roadway network 10, a voltages is generated by coil 64 carried by the vehicle even if the vehicle is not moving on the roadway network 10. However, a long charging time would be required for charging the vehicle battery 51. Such charging time could be substantially reduced by increasing the voltage applied to the alternating-current coil 63. If the voltage is sufficiently high, recharging of the battery 51 could be effected in a relatively short time while the vehicle is either stationary or moving along the roadway network.

FIG. 6 illustrates the option wherein the electrical energy transfer devices of the electrical distribution network 20 include coils 66 and 67 embedded in the roadway network 10 at each location W (FIGS. 1, 3 and 4), with each coil conducting electrical current alternating in direction in adjacent coils. Thus, each coil 66 carries a direct current flowing in one direction, and its next adjacent coil 67 carries current flowing in the opposite direction.

As further schematically shown in FIG. 6, each electrical energy transfer device carried by the vehicle 50 is in the form of a coil 64 carried on the vehicle and used for recharging a battery 51 also carried on the vehicle. Thus, as the vehicle 50 in FIG. 6 travels in the direction indicated by arrow 65 along the roadway network 10, coil 64 carried by the vehicle generates an electrical voltage as it passes sequentially over coils 66 and 67 embedded in the roadway network, creating an alternating magnetic field, to generate a voltage for charging the battery 51 carried by the vehicle.

FIG. 7 illustrates a further option of electrical energy transfer devices that may be used for transferring electrical energy from the electrical distribution network to the vehicles 50 traveling on the roadway network 10. In this option, the electrical energy transfer devices of the electrical distribution network 20 include one or more electrically-conductive strips 68 embedded in the roadway network 10 and energized by the plurality of renewable electrical energy sources 30 of the electrical distribution network 20; and the energy transfer devices of the electrical vehicles 50 include one or more electrical contactors 69 carried by each electrical vehicle and movable in electrical contact with the embedded electrically-conductive strips 68. The embedded electrically-conductive strips 68 thus serve as a third rail for supplying electricity to the vehicle 50. In FIG. 7, two parallel electrically conductive strips 68 are schematically illustrated for transferring electrical energy to the electrical contacts 69 carried by the electrical vehicle.

While the invention has been described with respect to several preferred embodiments, it will be appreciated that these are set forth merely for purposes of example, and that many other variations, modifications and applications of the invention may be made.

What is claimed is:

1. A method of efficiently exploiting renewable electrical energy sources, comprising:
constructing an electrical distribution network along and proximal to a roadway network traveled by electrical vehicles;
introducing a plurality of renewable electrical energy sources into said electrical distribution network at a plurality of spaced locations in the electrical distribution network;
utilizing said plurality of renewable electrical energy sources in said electrical distribution network for powering fixed electrical facilities located along and proximal to said roadway network;
and utilizing said plurality of renewable electrical energy sources in said electrical distribution network also for powering mobile electrical vehicles traveling on said roadway network via electrical energy transfer devices in the electrical distribution network and on the electrical vehicles.

2. The method according to claim 1, wherein said method further comprises:
constructing a data communication network along and proximal to said roadway network;
and providing said electrical distribution network with access points for enabling wireless access to said data communication network by travelers along said roadway network.

3. The method according to claim 1, wherein said method further comprises:
providing an energy storage system for temporarily storing energy outputted by said renewable electrical energy sources until utilized for powering said fixed electrical facilities and said electrical vehicles.

4. The method according to claim 1, wherein said renewable electrical energy sources include wind-turbines each is driving an electrical generator for generating electrical energy from the wind.

5. The method according to claim 1, wherein said renewable electrical energy sources include solar panels for generating electrical energy from the sun.

6. The method according to claim 1, wherein said electrical energy transfer devices in the electrical distribution network include electrical sockets at fixed locations of the electrical distribution network, and electrical plugs carried by the electrical vehicles for charging batteries carried by the electrical vehicles.

7. The method according to claim 1, wherein:
said energy transfer devices of the electrical distribution network include coils embedded in the roadway network, each conducting electrical energy outputted from the renewable electrical energy sources in the form of alternating current;
and said electrical energy transfer devices of the electrical vehicles include a coil carried by each electrical vehicle and inductively coupled to said embedded coils when the electrical vehicle is located thereover on the roadway network.

8. The method according to claim 1, wherein:
said electrical energy transfer devices of the electrical distribution network include a linear array of coils embedded in the roadway network, each conducting electrical energy outputted from the renewable electrical energy sources in the form of current alternating in direction in adjacent coils;
and said electrical energy transfer devices of the electrical vehicles include a coil carried by each electrical vehicle and inductively coupled to said embedded coils as the electrical vehicle moves over the roadway network.

9. The method according to claim 1, wherein:
said electrical energy transfer devices of the electrical distribution network include an electrically-conductive strip embedded in the roadway network;
and said electrical energy transfer devices of the electrical vehicles include an electrical contactor carried by each of said electrical vehicles and movable in electrical contact with said electrically-conductive strip embedded in the roadway network as the electrical vehicle moves over the roadway network.

10. A system for efficiently exploiting renewable electrical energy sources, comprising:
an electrical distribution network constructed along and proximal to a roadway network traveled by electrical vehicles;
a plurality of renewable electrical energy sources introduced into said electrical distribution network at a plurality of spaced locations in the electrical distribution network, said plurality of renewable electrical energy sources being connected to said electrical distribution network to power fixed electrical facilities located along and proximal to said roadway network;
and a plurality of electrical energy transfer devices in the electrical distribution network and on the electrical vehicles for transferring power from said electrical distribution network to said electrical vehicles.

11. The system according to claim 10, wherein said system further comprises:
a data communication network constructed along and proximal to said roadway network; said electrical distribution network being provided with access points for enabling wireless access to said data communication network by travelers along said roadway network.

12. The system according to claim 10, wherein said system further comprises:
an energy storage system for temporarily storing energy outputted by said renewable electrical energy sources until utilized for powering said fixed electrical facilities and said electrical vehicles.

13. The system according to claim 10, wherein said renewable electrical energy sources include wind-turbines each is driving an electrical generator for generating electrical energy from the wind.

14. The system according to claim 10, wherein said renewable electrical energy sources include solar panels for generating electrical energy from the sun.

15. The system according to claim 10, wherein said electrical energy transfer devices in the electrical distribution network include electrical sockets at fixed locations of the electrical distribution network, and electrical plugs carried by the electrical vehicles for charging batteries carried by the electrical vehicles.

16. The system according to claim 10, wherein:
said electrical energy transfer devices of the electrical distribution network include coils embedded in the roadway network, each conducting electrical energy outputted from the renewable electrical energy sources in the form of alternating current;
and said electrical energy transfer devices of the electrical vehicles include a coil carried by each electrical vehicle and inductively coupled to said embedded coils when the electrical vehicle is located thereover on the roadway network.

17. The system according to claim 10, wherein:
said electrical energy transfer devices of the electrical distribution network include a linear array of coils embedded in the roadway network, each conducting electrical energy outputted from the renewable electrical energy sources in the form of current alternating in direction in adjacent coils;
and said electrical energy transfer devices of the electrical vehicles include a coil carried by each electrical vehicle and inductively coupled to said embedded coils as the electrical vehicle moves over the roadway network.

18. The system according to claim 10, wherein:
said electrical energy transfer devices of the electrical distribution network include an electrically-conductive strip embedded in the roadway network;
and said electrical energy transfer devices of the electrical vehicles include an electrical contact carried by each of said electrical vehicles and movable in electrical contactor with said electrically-conductive strip embedded in the roadway network as the electrical vehicle moves over the roadway network.
